(19) United States
(12) Patent Application Publication
(10) Pub. No.: US 2025/0331598 A1
(43) Pub. Date: Oct. 30, 2025

(54) METHODS FOR FORMING A WATERPROOF ARTICLE OF FOOTWEAR

(71) Applicant: NIKE, Inc., Beaverton, OR (US)

(72) Inventors: Jordan M. Brooks, Portland, OR (US); Bryant Chu, Portland, OR (US); Fanny Yung Ho, Portland, OR (US); Daniel P. Morgan, Portland, OR (US); George A. Xanthos, Beaverton, OR (US)

(73) Assignee: NIKE, Inc., Beaverton, OR (US)

(21) Appl. No.: 19/097,048

(22) Filed: Apr. 1, 2025

Related U.S. Application Data
(60) Provisional application No. 63/639,072, filed on Apr. 26, 2024.

(51) Int. Cl. A43B 1/10; A43B 23/06; B29D 35/12; B29D 35/14

(52) U.S. Cl. CPC A43B 1/10; A43B 23/06; B29D 35/126; B29D 35/146

(57) ABSTRACT

A method for forming an article of footwear can include arranging a scaffold layer over a last having a shape of the article of footwear to form a scaffold assembly, where the scaffold layer comprises a textile with a mesh structure. The method can further include applying a liquid rubber to an upper portion and sole portion of the scaffold assembly to form one or more layers of rubber over the scaffold layer of the scaffold assembly, thereby forming a seamless article of footwear, and removing the formed article of footwear from the last.

### CROSS-REFERENCE TO RELATED APPLICATIONS

This application claims the benefit of U.S. Provisional Patent Application No. 63/639,072, filed Apr. 26, 2024, which is incorporated by reference herein in its entirety.

### FIELD

This disclosure relates generally to articles of footwear and, in particular to systems and methods for forming articles of footwear that are waterproof.

### BACKGROUND

An article of footwear typically includes two main components: a sole structure and an upper. The sole structure is configured for supporting the wearer's foot and providing cushioning between the wearer's foot and the ground. The sole structure may include an outsole that is adapted to contact the ground. The upper is coupled to the sole structure and is configured for securing the wearer's foot to the sole structure. In some examples, articles of footwear, such as rain or other outdoor boots, can be made of waterproof or water-resistant materials.

### BRIEF DESCRIPTION OF THE DRAWINGS

FIG. 1 is a perspective view of a waterproof article of footwear.

FIG. 2 is a side view of the article of FIG. 1.

FIG. 3 is a bottom, perspective view of the article of FIG. 1.

FIG. 4A is a schematic side view of the article of FIG. 1 superimposed over a more traditional article of footwear.

FIG. 4B is a schematic top view of the article of FIG. 1 superimposed over a more traditional article of footwear.

FIG. 5A is a side view of a first article of footwear having a first pleat and traction feature arrangement.

FIG. 5B is a perspective view of the first article of FIG. 5A.

FIG. 6A is a side view of a second article of footwear having a second pleat and traction feature arrangement.

FIG. 6B is a perspective view of the second article of FIG. 6A.

FIG. 7A is a side view of a third article of footwear having a third pleat and traction feature arrangement.

FIG. 7B is a perspective view of the third article of FIG. 7A.

FIG. 8A is a side view of a fourth article of footwear having a fourth pleat and traction feature arrangement.

FIG. 8B is a perspective view of the fourth article of FIG. 8A.

FIGS. 9A-9F depict waterproof articles of footwear with various pleat arrangements, including pleats around the opening of the upper.

FIG. 10 is a perspective bottom view of a waterproof article of footwear having features on a bottom of the outsole for increased traction.

FIGS. 11A-11C depict waterproof articles of footwear with various pleat arrangements at the opening or cuff of the articles.

FIGS. 12A-12E depict waterproof articles of footwear with varying pull tab configurations.

FIG. 13A depicts a waterproof article of footwear comprising cushion strips integrated into the upper portion of the shaft of the upper of the article.

FIG. 13B depicts the waterproof article of footwear of FIG. 13A with pull tabs connected to a portion of the cushion strips.

FIG. 14 depicts a waterproof article of footwear that comprises looped cushion elements which are integral with the upper of the article and pull tabs extending from the cushion elements.

FIGS. 15A and 15B depict examples of soft cuffs for waterproof articles of footwear.

FIGS. 16A and 16B depict examples of adjustable cuffs defining an opening of a waterproof article of footwear.

FIG. 17 is a perspective view of an exemplary scaffold layer for a waterproof article of footwear.

FIG. 18 is a top perspective view of the scaffold layer of FIG. 17, without pull tabs.

FIG. 19 is a perspective view of the article of FIG. 17 with an inner liner adhered to the scaffold layer with an adhesive.

FIG. 20 depicts a scaffold layer for a waterproof article of footwear, the scaffold layer comprising a textile mesh structure arranged around a last and being dipped into a liquid natural rubber.

FIG. 21 depicts the scaffold layer with a first rubber layer formed therein and a sock being rolled over the wet first rubber layer.

FIG. 22 depicts the assembly of FIG. 21 turned inside out to reveal a patterned outsole on the formed waterproof article of footwear.

FIG. 23 depicts a scaffold layer for a waterproof article of footwear, the scaffold layer comprising a textile mesh structure arranged over a sockliner.

FIG. 24 depicts the scaffold layer arranged over the sockliner, which is arranged over a last, being dipped into a liquid natural rubber.

FIG. 25 depicts a bottom of the assembly from FIG. 24 being dipped into a different liquid natural rubber to form an outsole of the waterproof article of footwear.

FIG. 26A is a bottom view of the article of footwear, with a thicker outsole formed by the methods shown in FIGS. 23-25.

FIG. 26B is a side perspective view of the article of FIG. 26A.

FIG. 27 is a side view of a waterproof article of footwear comprising a textile mesh scaffold layer and one or more rubber layers, where the article has a longer shaft and wider ankle region.

FIG. 28 is a side view of a waterproof article of footwear comprising a textile mesh scaffold layer and one or more rubber layers, where the article has a longer shaft and narrower ankle region.

FIG. 29 is a side view of a waterproof article of footwear comprising a textile mesh scaffold layer and one or more rubber layers, where the article has a shorter shaft and narrower ankle region.

FIG. 30 is a side view of a waterproof article of footwear comprising a textile mesh scaffold layer and one or more rubber layers, where the article has a shorter shaft and wider ankle region.

FIG. 31 is an exemplary scaffold layer for a waterproof article of footwear, the scaffold layer comprising fibers knit such that protruding baffles are formed on the scaffold layer.

FIG. 32 is an exemplary foot form for forming a waterproof article of footwear, the foot form comprising longitudinally extending ridges.

FIG. 33 is an exemplary foot form for forming a waterproof article of footwear, the foot form comprising longitudinally extending ridges and ridges extending across an ankle region of the foot form.

FIG. 34 depicts the foot form of FIG. 33 being dipped into a liquid natural rubber.

FIG. 35 depicts a first rubber layer formed on the foot form of FIG. 33 after dipping.

FIG. 36A is a first perspective view of a waterproof article of footwear formed by applying multiple layers of liquid natural rubber to the foot form of FIG. 33 and curing them thereon, the article comprising pleats formed by the ridges of the foot form.

FIG. 36B is a second perspective view of the article of FIG. 26A.

### DETAILED DESCRIPTION

### General Considerations

The systems and methods described herein, and individual components thereof, should not be construed as being limited to the particular uses or systems described herein in any way. Instead, this disclosure is directed toward all novel and non-obvious features and aspects of the various disclosed examples, alone and in various combinations and subcombinations with one another. For example, any features or aspects of the disclosed examples can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application the singular forms “a,” “an,” and “the” include the plural forms unless the context clearly dictates otherwise. Additionally, the term “includes” means “comprises.” Further, the term “coupled” or “secured” encompasses mechanical and chemical couplings, as well as other practical ways of coupling or linking items together, and does not exclude the presence of intermediate elements between the coupled items unless otherwise indicated, such as by referring to elements, or surfaces thereof, being “directly” coupled or secured. Furthermore, as used herein, the term “and/or” means any one item or combination of items in the phrase.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

For purposes of this disclosure, portions of an article of footwear (and the various component parts thereof) may be identified based on regions of the foot located at or near that portion of the article of footwear when the footwear is worn on the properly sized foot. For example, an article of footwear and/or a sole structure may be considered as having a “forefoot region” at the front of the foot, a “midfoot” region at the middle or arch area of the foot, and a “heel region” at the rear of the foot. Footwear and/or sole structures also include a “lateral side” (the “outside” or “little toe side” of the foot) and a “medial side” (the “inside” or “big toe side” of the foot). The forefoot region generally includes portions of the footwear corresponding to the toes and the joints connecting the metatarsals with the phalanges. The midfoot region generally includes portions of the footwear corresponding with the arch area of the foot. The heel region generally corresponds with the rear portions of the foot, including the calcaneus bone. The lateral and medial sides of the footwear extend through the forefoot, midfoot, and heel regions and generally correspond with opposite sides of the footwear (and may be considered as being separated by a central longitudinal axis). These regions and sides are not intended to demarcate precise areas of footwear. Rather, the terms “forefoot region,” “midfoot region,” “heel region,” “lateral side,” and “medial side” are intended to represent general areas of an article of footwear and the various components thereof to aid the in discussion that follows.

For purposes of this disclosure, directional adjectives may be employed which correspond to the illustrated example. For example, the term “longitudinal” as used herein refers to a direction extending a length of an article. In some cases, the longitudinal direction may extend from a forefoot portion to a heel portion of the article. Also, the term “lateral” as used herein refers to a direction extending a width of an article. In other words, the lateral direction may extend between a medial side and a lateral side of an article. Furthermore, the term “vertical” as used herein refers to a direction generally perpendicular to a lateral and longitudinal direction. For example, in cases where an article is planted flat on a ground surface, the vertical direction may extend from the ground surface upward. It will be understood that each of these directional adjectives may be applied to individual components of an article, such as an upper and/or a sole structure.

As used herein, the term “exemplary” means serving as a non-limiting example, instance, or illustration. As used herein, the terms “e.g.,” and “for example,” introduce a list of one or more non-limiting examples, instances, and/or illustrations.

As used herein, the term “sole structure” refers to any combination of materials that provides support for a wearer's foot and bears the surface that is in direct contact with the ground or playing surface, such as, for example, a single sole; a combination of an outsole and an inner sole; a combination of an outsole, a midsole, and an inner sole; and a combination of an outer covering, an outsole, a midsole and an inner sole.

As used herein, the terms “attached” and “coupled” generally mean physically connected or linked, which includes items that are directly attached/coupled and items that are attached/coupled with intermediate elements between the attached/coupled items, unless specifically stated to the contrary.

As used herein, the terms “articles of footwear” or “articles” mean any type of footwear, including, for example, basketball shoes, volleyball shoes, tennis shoes, running shoes, soccer shoes, football shoes, rugby shoes, baseball shoes, sneakers, hiking boots, sandals, socks, etc.

As used here, the term “natural rubber” refers to a material that includes natural rubber harvested from a natural source, such as a rubber tree, but does not exclude other additives within the natural rubber. For example, the term “natural rubber” can refer to a rubber that includes mostly natural rubber (e.g., at least 80%), but may include some additives, such as thickening agents, colorants, or the like.

Although the figures may illustrate an article of footwear intended for use on only one foot (e.g., a right foot) of a wearer, one skilled in the art and having the benefit of this disclosure will recognize that a corresponding article of footwear for the other foot (e.g., a left foot) would be a mirror image of the right article of footwear.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the detailed description, claims, abstract, and drawings.

### The Disclosed Technology

An article of footwear typically includes two main components: a sole structure and an upper. The sole structure is configured for supporting the wearer's foot and providing cushioning between the wearer's foot and the ground (e.g., the surface on which they are moving, walking, running, etc.). The upper is coupled to the sole structure and forms a foot-receiving cavity. The upper is configured for securing the wearer's foot to the sole structure and/or can protect the wearer's foot.

In some examples, articles of footwear can be waterproof, such as in the case of rain boots. However, waterproof coatings or materials used to make such waterproof (or water resistant) articles of footwear can be made with materials that are unsustainable and/or harmful to the environment, such as fossil fuel-based materials.

Typical rain boots (or shoes) can be thick, stiff, heavy, ill fitting, and/or buckle in uncomfortable places. As a result, these rain boots can be uncomfortable and make it difficult to move naturally, particularly for children with growing feet who like to run around and play.

Disclosed herein are articles of footwear, and methods for forming such articles of footwear, that comprise one or more layers of a rubber material, and that are flexible and easy to manufacture. Such articles of footwear can be, in some examples, bio-based performance articles of footwear that protect children (and adults) from the elements (e.g., rain, water, mud, and the like) and promote comfortable play outdoors.

In some examples, such articles of footwear can be boots comprising an upper and sole structure that are seamlessly produced with a natural rubber, such as natural rubber latex obtained from trees.

In some examples, such articles of footwear can be shoes comprising an upper and sole structure that are seamlessly produced with a natural rubber, such as natural rubber latex obtained from trees.

In some examples, the natural rubber used to make such articles can be obtained from a natural and renewable resource (e.g., trees), thereby making the articles more sustainable than more traditional waterproof shoes or boots. Further, the natural rubber can be waterproof, elastomeric, and biodegradable, thereby making the articles of footwear described herein better for the environment, while also having ideal performance characteristics for children (e.g., flexibility and waterproof).

As described herein, in some examples, the natural rubber (e.g., natural rubber latex) can be combined with textiles to form a waterproof article of footwear that can also be flexible, durable, soft, and/or resistant to abrasion. For example, in some instances, the articles of footwear described herein can comprise a first scaffold layer and a second waterproof layer or coating that forms a waterproof skin over the first scaffold layer. In some examples, the scaffold layer can comprise a textile, such as a knit or non-woven textile. In some examples, the scaffold layer has a mesh structure with open cells.

As described herein, in some examples, the natural rubber (e.g., natural latex rubber) can be layered onto a pleated (or ridged) foot form that comprises one or more ridges or pleats that provides flexibility to the article of footwear after being removed from the foot form.

The methods described herein can include applying (e.g., via dipping or spraying) a liquid, natural rubber to various scaffolds or foot forms to form one or more layers over the scaffolds or foot forms. Such processes can be fast and affordable and produce articles of footwear that are waterproof, flexible, lightweight, sustainable, and biodegradable. In this way, these articles of footwear can be more natural or bio-based, and function as a comfortable and waterproof article of footwear.

In some examples, a method for forming an article of footwear comprises arranging a scaffold layer over a last having a shape of the article of footwear to form a scaffold assembly, wherein the scaffold layer comprises a textile with a mesh structure. The method further comprises applying a liquid rubber to an upper portion and sole portion of the scaffold assembly to form one or more layers of rubber over the scaffold layer, thereby forming a seamless article of footwear. The method further comprises removing the formed article of footwear from the last.

In some examples, an article of footwear comprises an inner scaffold layer, wherein the inner scaffold layer comprises textile fibers that are knit together to define a mesh structure having open cells. The article further comprises one or more rubber layers comprising a rubber disposed over and within the open cells of the inner scaffold layer, wherein the article is seamless and together the inner scaffold layer and one or more rubber layers define an upper and sole member of the article that are formed as one piece.

In some examples, a method for forming an article of footwear comprises applying a liquid rubber to a foot form to form a first layer of rubber over the foot form, wherein the foot form comprises an upper portion and a sole portion, and wherein the upper portion comprises a plurality of spaced apart ridges that protrude outward from a base surface of the foot form. The method further comprises applying the liquid rubber to the first layer of rubber on the foot form to form a second layer of rubber over the first layer of rubber. The method further comprises curing the first and second layers of rubber on the foot form, thereby forming the article of footwear comprising an outsole and an upper that are seamless with one another, and wherein the upper comprises a plurality of pleats having a shape of the plurality of spaced apart ridges. The method further comprises removing the formed article of footwear from the foot form.

In some examples, an article of footwear comprises an upper and outsole that are seamless with one another, where the upper and outsole comprise one or more layers of rubber, and where the upper comprises a plurality of spaced apart pleats in an ankle region of the upper that are configured to increase bendability of the upper in the ankle region.

Additional examples of the disclosed technology are described below with reference to the accompanying drawings.

### Examples of the Disclosed Technology

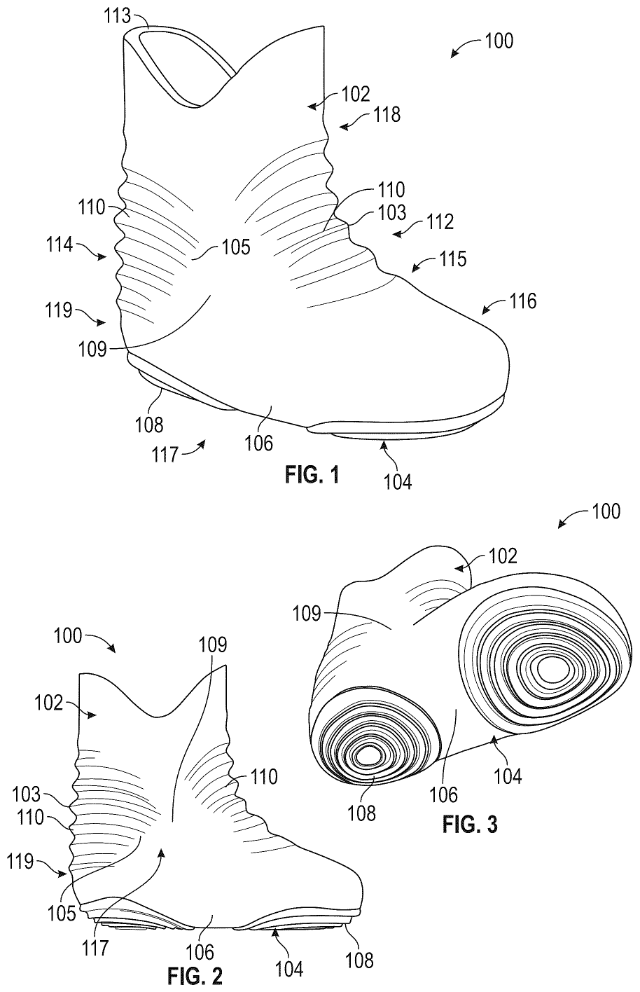

FIGS. 1-3 depict an exemplary article of footwear 100 (perspective, side, and bottom perspective, respectively) which can also be referred to simply as the article 100. The article 100 comprises an upper 102 and a sole structure 104.

In some examples, the article 100 can be a boot. In some examples, the article 100 can have a differently shaped upper 102, such as a lower profile (e.g., shorter) upper or an upper having a different shape that is similar to a causal or athletic shoe. Although the figures described herein, such as FIGS. 1-3, depict the articles as being boots, it should be noted that the methods and material described herein can be used to form different types of water-resistant or waterproof footwear, such as loafers, high heeled footwear, slippers, athletic shoes, hiking shoes, or the like. Moreover, in some examples, the article 100 may be configured for use as an article of apparel (e.g., jackets, hats, gloves, or the like).

In some examples, the sole structure 104 can be configured to provide traction for the article 100. In addition to providing traction, the sole structure 104 may attenuate ground reaction forces when compressed between the foot and the ground during walking, running, or other ambulatory activities. The configuration of the sole structure 104 can vary in different examples to include a variety of conventional or non-conventional structures. The sole structure 104 extends between the upper 102 and the ground when the article 100 is worn. In different examples, the sole structure 104 can include different components. For example, the sole structure 104 can include an outsole, a midsole, and/or an insole. In some cases, one or more of these components may be optional.

In the example shown in FIGS. 1-3, the sole structure 104 comprises an outsole 106. In some examples, the upper 102 and the outsole 106 are continuous with one another (e.g., formed together with a seamless construction by applying a liquid rubber material to a scaffold or foot form, as described in detail below).

In some examples, an insole can be arranged within the article, above the outsole 106, thereby providing cushioning and/or support to a wearer's foot.

In some examples, the sole structure 104 can comprise a midsole, such as a cork midsole.

In some instances, the outsole 106 of the sole structure 104 can be configured according to one or more types of ground surfaces on which outsole 106 can be used. Examples of ground surfaces include, but are not limited to: natural turf, synthetic turf, dirt, natural grass, soft natural grass, as well as other surfaces. In some examples, the outsole 106 can comprise one or more traction surfaces or elements, such as cleats, lugs, ridges, or the like.

As shown in the example of FIGS. 1-3, in some instances, the outsole 106 can comprise groupings of spaced apart ridges 108 that provide traction to the article 100. In some examples, as shown in FIG. 3, the ridges 108 are formed as spaced apart rings that may simulate a wave pattern.

In other examples, the ridges 108 can be linear, wavy, or form other patters across the outsole 106.

The article 100, including the upper 102 and the sole structure 104, can comprise one or more layers of a natural rubber material, such as a natural rubber latex. In some examples, the natural rubber latex is Vytex, which is produced from the Hevea Brasiliensis tree. As such, the natural rubber used to form the article 100 can be natural and renewable. The natural rubber latex used to form the article 100 is biodegradable, thereby being environmentally friendly. The natural rubber is also waterproof, elastomeric, and adhesive (e.g., it can adhere to various materials, such as textiles and itself when being used to form multiple layers).

As introduced above, in some examples, the natural rubber materials disclosed herein can include additives. For example, the term “natural rubber” can refer to a natural rubber obtained from a natural source (e.g., trees) that includes mostly natural rubber (e.g., at least 80%), but may include some additives, such as thickening agents, colorants, or the like (which is described in greater detail below).

Although the articles and methods described herein may be described as comprising and using natural rubber, in some examples, the articles and methods described herein may instead comprise and use synthetic rubber materials such as neoprene or silicones. In this way, liquid synthetic rubbers can be used in place of the liquid natural rubbers in the methods described herein. Further, in some examples, the methods described herein can be used with liquid polymers, other than rubber, to coat scaffolds or forms for articles of footwear or other articles.

As described in more detail below, the natural rubber can be in a liquid form when applying (e.g., by spraying or dipping) to a scaffold or foot form to form the article 100. The liquid natural rubber is then curable on the scaffold or foot form (e.g., via time, heat, light, or a combination thereof) such that it solidifies and forms the article 100 to be worn by a user.

A target number of layers of the natural rubber for the article 100 can be specified based on desired performance characteristics of the article 100, such as flexibility. In some examples, the outsole 106 can comprise more layers of the natural rubber than the upper 102. Additional layers of rubber on the outsole 106 can provide a more durable outsole with increased hardness.

In some examples, natural rubbers having various durometers can be used. For example, in some instances, a higher durometer natural rubber can be used in portions of the article 100 where a greater hardness is advantageous, such as the outsole 106. As an example, the upper 102 can comprise a first natural rubber having a first durometer and the outsole 106 can comprise a second natural rubber having a second durometer, the second durometer being higher than the first durometer. In this way, a same material (natural rubber) having different material properties (e.g., durometer) can be used to achieve different hardnesses and flexibility in different regions of the article 100.

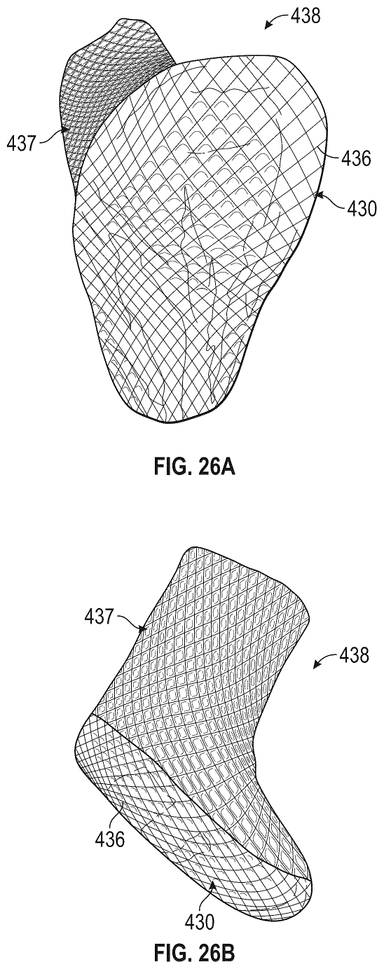

In some examples, as described further below with reference to FIGS. 26A and 26B, natural rubbers having different colors (e.g., the same natural rubber dyed with differently colored colorants, such as food coloring) can be used in different regions of the article 100 or in different articles. For example, in some instances, the outsole 106 can comprise the natural rubber having a first color or streaks of a first color that is different than a color of the upper 102 or a different outsole of a different article.

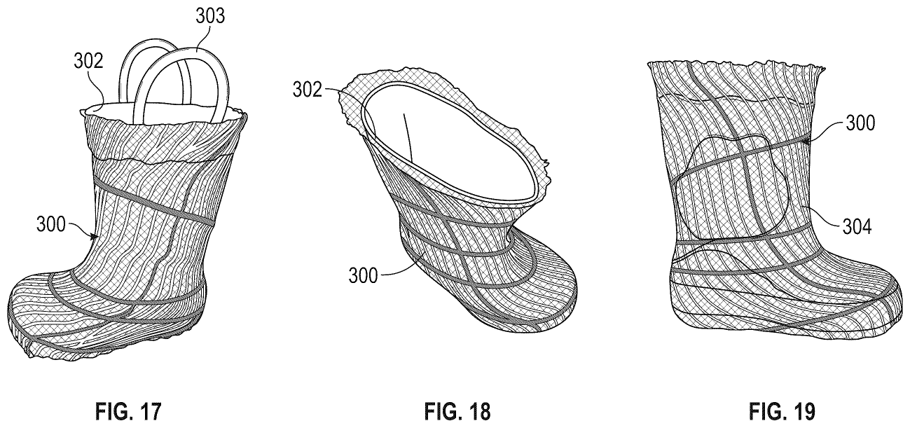

In some examples, the upper 102 can comprise an inner liner or lining sock (which can also be referred to herein as a sockliner), such as shown in FIGS. 17-18 and 21-25, as described further below. As described in more detail below, in such instances, the upper 102 can comprise an inner liner or lining sock with one or more layers of natural rubber disposed over the inner liner or lining sock.

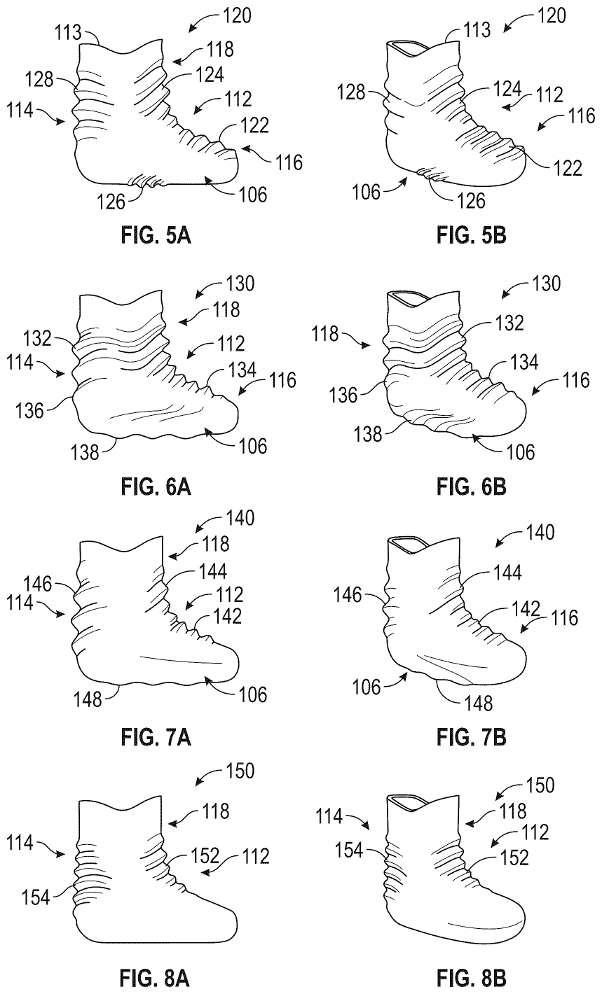

In some examples, as shown in FIGS. 1-3, the upper 102 can comprise one or more pleats 110 (which can also be referred to as folds). The pleats 110 can be arranged on various regions of the upper 102 (and in some instances, the sole structure 104) and in various patterns, numbers, and shapes, as described in more detail below with reference to FIGS. 5A-15B.

In some instances, the pleats 110 can be formed in and be part of the one or more layers of natural rubber. The pleats 110 allow the rubber layers to bend more, thereby providing increased flexibility to the article 100 in targeted areas (the areas of the pleats). By arranging the pleats 110 in specified patterns across the article 100, the article 100 can have a desired flexibility for providing natural movement for various age groups (e.g., children) and/or for various activities (e.g., running, jumping, walking, hiking, or the like).

In the example of FIGS. 1-3, the pleats 110 are arranged on a front ankle region 112 and rear ankle region 114 of the article. In each of the front ankle region 112 and rear ankle region 114, there are multiple pleats 110 arranged adjacent to one another.

For example, the pleats 110 in the front ankle region 112 can be spaced apart from one another, from a central portion of the front ankle region 112 up a shaft 118 of the article 100 and down toward a toe region 116 of the article 100. Each pleat 110 can extend across the front ankle region 112 from a medial side 115 to a lateral side 117 of the article 100.

Similarly, the pleats 110 in the rear ankle region 114 can be spaced apart from one another, from a central portion of the rear ankle region 114 up the shaft 118 of the article 100 and down toward or onto a heel region 119 of the article 100. Each pleat 110 can extend across the rear ankle region 114 from a medial side 115 to a lateral side 117 of the article 100.

By arranging the pleats 110 in the regions shown in FIGS. 1-3, the article 100 can bend more in the front and rear ankle regions 112, 114, thereby giving the wearer more flexibility in their ankle as they move around in the article 100.

In some examples, the pleats 110 can have varying lengths (as measured from a first end of the pleat 110 of the medial side 115 to an opposite, second end 105 of the pleat 110 on the lateral side 117).

In some examples, the pleats 110 can have varying widths (as measured in a direction from the outsole 106 to the opening 113 of the upper 102 or a direction from the toe region 116 to the opening 113).

In some examples, as shown in the example of FIGS. 1-3, the pleats 110 can fade into a base structure 109 (or surface not having pleats, e.g., a non-pleated portion) of the upper 102. For example, a height of the pleats 110 (in a direction outward from an interior of the article 100 and away from an outer surface of the article 100) can be highest at a center 103 of the pleats 110 (midpoint between the opposite first and second ends) and decrease toward the first and second ends until the pleat 110 blends into the base structure 109 of the upper 102.

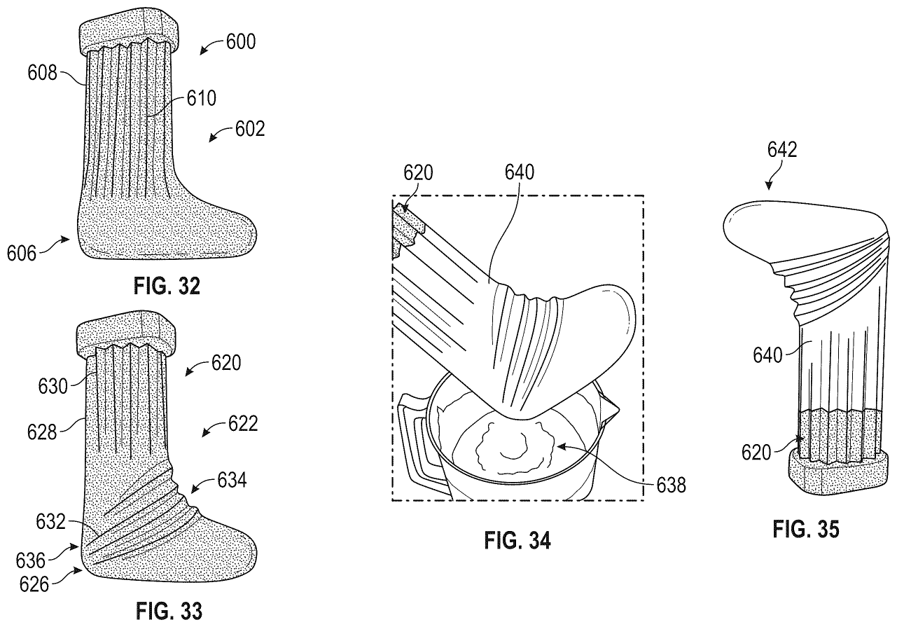

In some examples, the pleats 110 are created by a foot form (having a desired shape of the article 100) which is dipped into the liquid natural rubber one or more times (or by spraying the liquid natural rubber onto the foot form) to form one or more layers of natural rubber over the foot form. When removed from the foot form, the resulting article, such as article 100, can have the shape of the foot form, including pleats (such as pleats 110). This method of forming the article 100, or other articles described herein, is described below with reference to FIGS. 32-37B.

In some examples, the upper 102 can comprise a scaffold layer (e.g., a textile scaffold) underneath and/or embedded in the one or more layers of the natural rubber. Examples of such scaffold layers are described below with reference to FIGS. 17-31.

In some instances, the article 100 may not include pleats 110, and instead increased flexibility can be created by a high stretch knit textile forming a scaffold layer of the article 100 underneath one or more layers of natural rubber, as explained further below with reference to FIGS. 17-31.

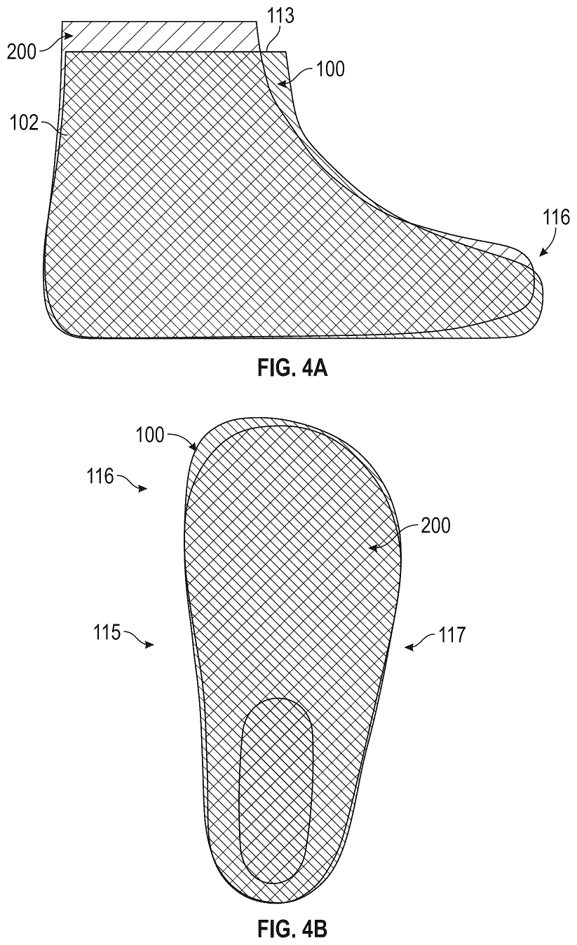

FIGS. 4A and 4B are schematic side (FIG. 4A) and top (FIG. 4B) views of the article 100 superimposed over a more traditional article of footwear 200 (e.g., a children's boot) for the sake of comparison. As shown in FIG. 4A, the article 100 has a wider entry at a top or opening 113 of the upper 102, as compared to the more traditional article 200. This provides easier entry for the wearer, particularly for younger children.

The article 100 can have a wider toe box, or toe region 116, as compared to the more traditional article 200 (as shown in FIG. 4B).

As shown in FIG. 4A, the article 100 can have a smaller (e.g., zero) toe spring, as compared to the more traditional article 100. For example, the toe region 116 of the article 100 can be closer to or flush with the ground surface when worn by a wearer and/or have less lift off the ground surface, as compared to the article 200.

These features of the article 100, in comparison to the more traditional article 200, can promotes healthy feet and natural movement. This can be particularly advantageous for children whose feet are developing and growing rapidly.

As noted above, the article 100, and similar articles, can have various arrangements and shapes of pleats (e.g. pleats 110). FIGS. 5A-8B depict various pleat arrangements and/or traction features for the articles of footwear described herein. In some examples, the pleats 110 and/or ridges 108 of the article 100 can be replaced by any one or combination of pleat arrangements shown in FIGS. 5A-8B.

Turning first to FIGS. 5A and 5B, a first article 120 having a first pleat arrangement is shown. In the first article 120, pleats 122 are spaced apart across the toe region 116 of the first article 120, each extending between the medial and lateral sides of the first article 120. The first article 120 also includes pleats 124 spaced across the front ankle region 112 and up the shaft 118 and pleats 128 spaced across the rear ankle region 114 (each extending between the medial and lateral sides of the article 120). In the example of first article 120, the pleats 122 are spaced away from the pleats 128 (they do not connect, cross, or overlap one another).

The first article 120 also includes pleats 126 arranged on the outsole 106 (e.g., in an arch region of the article 120). The pleats 126 can provide increased bendability in the arch region. In some examples, the pleats 126 can also provide traction to the outsole 106.

FIGS. 6A and 6B depict a second article 130 having a second pleat arrangement. The second article 130 includes pleats 132 which extend around an entirety (entire circumference) of the shaft 118. The second article 130 also includes pleats 134 which are spaced apart from the front ankle region 112 to the toe region 116 of the article 130. The second article 130 also includes at least one pleat 136 on the rear ankle region 114 that does not extend around the entire circumference of the shaft 118.

The second article 130 also includes pleats 138 spaced apart along the outsole 106. The pleats 138 can be wider and/or spaced further apart from one another than the pleats 126 of the first article 120 (FIGS. 5A and 5B). Further, the pleats 138 can cover more of the outsole 106 (extend further along a length of the outsole 106, as measure from heel to toe) than the pleats 126.

FIGS. 7A and 7B depict a third article 140 having a third pleat arrangement. The third article 140 includes pleats 142 that are spaced apart across the toe region 116, each extending between the medial and lateral sides of the third article 140. As compared to the pleats 122 of the first article 120, the pleats 142 are shorter in length and do not extend as close to the toe region 116 of the third article 140.

The third article 140 also includes pleats 144 spaced apart across the front ankle region 112 and up the shaft 118 and pleats 146 spaced apart across the rear ankle region 114 and up the shaft 118 (each extending between the medial and lateral sides of the article 120). As compared to the pleats 124 and 128 of the first article 120, the pleats 144 and 146 are shorter in length.

The third article 140 also includes wider waves or pleats 148 arranged on the outsole 106. The pleats 148 can provide bendability and/or traction to the outsole 106.

FIGS. 8A and 8B depict a fourth article 150 having a fourth pleat arrangement. The fourth article 150 includes pleats 152 spaced apart across the front ankle region 112 and up the shaft 118 and pleats 154 spaced apart across the rear ankle region 114 and up the shaft 118 (each extending between the medial and lateral sides of the article 120). As compared to the pleats 124 and 128 of the first article 120, the pleats 152 and 154 can have a smaller width and are closer together, thus resulting in a greater number of pleats 152 in the front ankle region 112 and a greater number of pleats 154 in the rear ankle region 114 that for the first article 120.

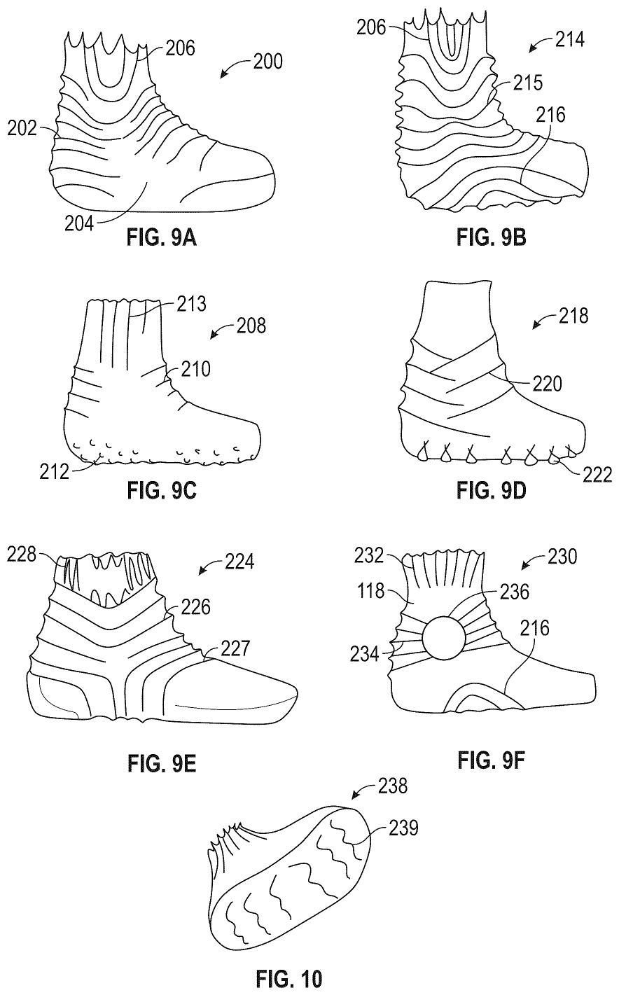

FIGS. 9A-16B depict various pleat arrangements, traction features, pull tab configurations, and cuffs for articles of footwear comprising one or more layers of natural rubber formed by applying liquid natural rubber to foot forms or scaffolds, as described herein. In some examples, the various features shown in FIGS. 5A-8B can replace the features or be included as additional features in the article 100 shown in FIGS. 1-3.

It should be noted that FIGS. 9A-16B are schematic. Further, all the articles shown in FIGS. 9A-16B can comprise an upper and sole structure similar to the upper 102 and sole structure 104 of article 100, as described above with reference to FIGS. 1-3.

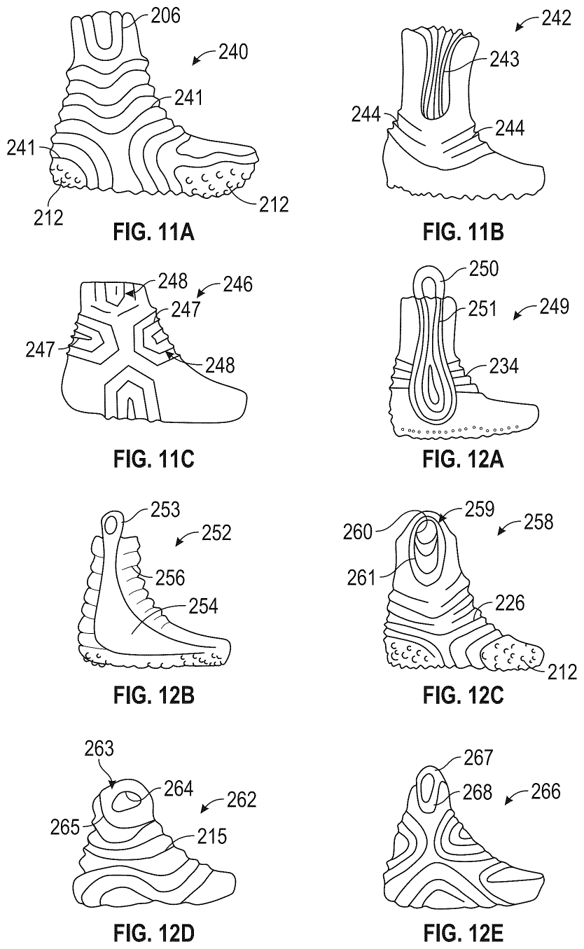

FIGS. 9A-9F depict articles with various pleat arrangements, including pleats around the opening of the upper. Turning first to FIG. 9A an article 200 includes wave-like pleats 202 that having varying lengths and fade (or taper) into the base structure 204 (or surface) of the article 200 (similar to pleats 110 of the article 100, as described above). The article 200 also includes U-shaped pleats 206 at a top portion of the upper, which extend to the opening of the upper. These U-shaped pleats 206 adjacent to the opening of the upper allow the opening to flex and open wider for easy entry of a wearer's foot into the article 200. Similar U-shaped pleats 206 are shown in FIGS. 9B and 11A.

FIG. 9B shows an article 214 including wave-like pleats 215 that extend around the upper (e.g., around an entirety of the upper, such as encircling the shaft of the upper) and pleats 216 that ripple outward and along the outsole.

FIG. 9C shows an article 208 including shorter, angled pleats 210 at the front and rear ankle regions. The article 208 also includes nubs 212 (or pebbles) along the outsole which can provide traction. The opening of the upper of the article 208 can include longitudinally extending pleats 213 (extending in a direction from the opening toward the outsole) that allow the opening to flex for easy entry of a wearer's foot into the article 208.

FIG. 9D shows an article 218 including longer angled pleats 220 that alternate between extending from the front ankle region and the rear ankle region. The article 218 also includes traction features 222 spaced apart along the outsole.

FIG. 9E shows an article 224 including angled pleats 226 of varying length that extend all the way or partially around the shaft of the upper. The article 224 also includes pleats 227 that extend either from the front ankle region or rear ankle region/heel region toward the outsole. The article 224 also includes a soft cuff 228. In some examples, the soft cuff 228 can comprise a fabric.

FIG. 9F shows an article 230 including pleats 232 that allow the opening to flex for easy entry of a wearer's foot into the article 208. In some examples, the pleats 232 can be angled slightly due to the article 230 tapering inward from a wider opening to a narrower shaft 118. The article 230 also includes a group of angled pleats 234 that each extend outward from a common center, such as circle 236 shown in FIG. 9F. This arrangement of pleats 324 can provide flex about a common pivot point (the circle 236), thereby providing the article 230 with increasing bendability in the ankle region.

As shown in FIG. 9F, the article 230 includes pleats 216 that ripple outward from the outsole.

FIG. 10 depicts an article 238 having features 239 on a bottom of the outsole for increased traction. In some examples, the features 239 are protruding members that protrude outward from a base surface of the outsole. In some examples, as shown in FIG. 10, the features 239 are wavy (shaped as a wave).

FIGS. 11A-11C depict articles with various pleat arrangements at the opening or cuff of the articles. Turning first to FIG. 11A, the article 240 includes pleats 206. As described above with reference to FIG. 9A, the U-shaped pleats 206 are disposed at a top portion of the upper, and extend to the opening of the upper, thereby providing flex at the opening easy entry of a wearer's foot into the article 240. The article 240 also includes wave-like pleats 241 that extend across the shaft of the upper and radiate outward from a heel region and toe region of the article 240. The article 240 also includes nubs 212 at the toe region and heel region of the outsole that provide traction.

In FIG. 11B, the depicted article 242 includes pleats 243 that extend from the opening of the upper of the article 242, down a shaft of the upper, toward the ankle region of the upper. The pleats 243 can be disposed on both the medial and lateral sides of the article 242 and extend along central portions of the shaft on the medial and lateral sides.

The article 242 can also include two sets of pleats 244, one on the front ankle region and one on the rear ankle region, that angle toward a central portion of the ankle region of the article but are spaced apart from one another and do not meet in the central portion of the ankle region. This arrangement can provide increased flexibility in the ankle of the article 242 and enabling it to bend in this region, similar to pleats 210 shown in FIG. 9C and pleats 226 shown in FIG. 9E, for example.

FIG. 11C depicts an article 246 comprising groups of pleats 247 that form flex regions 248 that are centered at the smallest pleat 247 within each group. As shown in FIG. 11C, the pleats 247 half a half-hexagonal shape. However, in alternate examples, the pleats 247 can be arc-shaped (as shown in FIG. 12E), triangular, or the like. As shown in FIG. 11C, the groups of pleats 247 forming the flex regions 248 can be disposed at the top or opening of the upper, front ankle region, rear ankle region, and arch region of the article 246, thereby enabling the article 246 to flex or bend to a greater extent (than regions without the flex regions 248) and providing a wearer with increased mobility.

FIGS. 12A-12E depict articles with varying pull tab configurations. FIGS. 12A-12E are side views, and thus shown only one pull tab. However, it should be understood that each article can include two pull tabs, one on each side of the article (for example, as shown in FIG. 14). Turning first to FIG. 12A, the article 249 has an integrated pull tab 250 that is integrated with the upper of the article 249. For example, the pull tab 250 can be continuous with features 251 that are configured as cushion elements embedded within the material of the upper or additional pleat elements. As shown in FIG. 12A, the features 251 extend downward from the opening of the article 242, along the shaft, toward the outsole of the article 242.

In FIG. 12B, the depicted article 252 includes a pull tab 253 that is integrated with the upper of the article 249. For example, the pull tab 253 can comprise a wider, arced portion 254 (shaped like a boomerang, in some examples) that is formed together with (or within) a remainder of the upper and extends along the shaft of the upper and across a lower portion of the upper, adjacent to the outsole, and toward the toe region of the article 252.

In some examples, the article 252 can include pleats 256 spaced apart across the front and rear portions of the shaft (on both sides of the arced portion 254 of the pull tab 253.

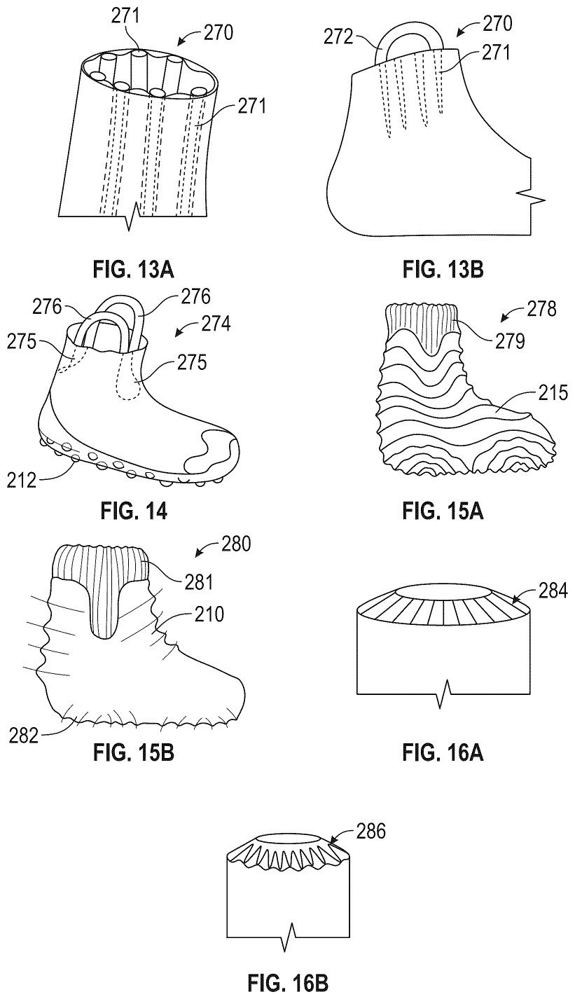

FIG. 12C shows an article 258 comprising a pull tab 259 that is formed with an upper portion of the shaft of the upper and that defines an opening of the upper. For example, instead of extending from the opening of the upper, as shown in FIGS. 13A and 13B, the pull tab 259 is formed within and defined by the upper portion of the shaft of the upper. More specifically, the pull tab 259 comprises a central opening 260 and circular features 261 surrounding and radiating outward from the central opening 260, which are configured as pleats or cushion elements.

FIG. 12D shows an article 262 with another type of integrated pull tab 263 that is similar to the pull tab 259 of FIG. 12C. However, the pull tab 263 can be formed into the upper portion of the shaft of the upper that defines the opening of the article 262 and be defined by a central opening 264 and surrounding arc feature 265.

FIG. 12E shows an article 266 with yet another type of integrated pull tab 267 that is similar to the pull tab 250, but it is integrated with an O-shaped cushion element 268 that extends only along an upper portion of the shaft of the upper.

FIGS. 13A and 13B depict an article 270 comprising cushion strips 271 integrated into (e.g., molded or formed together with) the upper portion of the shaft of the upper of the article 270. Each cushion strip 271 extends from the opening of the upper toward an ankle region of the article 270, and the cushion strips 271 are spaced apart from one another around the opening. In some examples, the cushion strips 271 are longitudinally extending (extend from the opening toward the outsole of the article 270).

In some examples, the cushion strips comprise foam.

In some examples, as shown in FIG. 13B, a pull tab 272 (or two pull tabs 272, one on the medial side and one on the lateral side of the article 270) is integral with (molded or formed as one piece with) and extends from two cushion strips 271 that are spaced apart from one another.

FIG. 14 depicts an article 274 that comprises looped cushion elements 275 which are integral with the upper of the article 274, similar to the cushion strips 271. A pull tab 276 is integrated with an end of each cushion element 275.

FIGS. 15A and 15B show different examples of soft cuffs for the articles described herein. For example, FIG. 15A depicts an article 278 comprising a cuff 279 extending around the opening of the article 278.

The article 280 depicted in FIG. 15B includes a similar cuff 281 that has a central portion that extends further along the shaft of the article 280 that in article 278.

The cuffs 279 and 281 can comprise a soft, flexible material, such as a knit textile (e.g., comprising natural fibers, as described herein). This can provide increased comfort to the wearer.

The article 280 can also include ripple elements 282 spaced apart along the outsole of the article 280 which provide traction and flexibility to the article 280.

FIGS. 16A and 16B show two examples of adjustable cuffs 284 and 286, respectively, that can define an opening of the article and can be cinched or closed around the leg of the wearer, thereby, shielding out the elements (e.g., dirt, debris, water, or the like) and keeping the foot of the wearer dry and warm. The cuffs 284 and 286 can comprise a flexibility material, such as a textile that is adjustable via a drawstring or another closure element.

FIGS. 17-25 depict methods for forming an article of footwear comprising a natural rubber material, such as any of the articles described herein, by dipping one or more scaffold layers which define a shape of the article into a liquid natural rubber. The resulting articles can comprise one or more scaffold layers (which may be textiles, as described further below) and one or more natural rubber layers formed over the scaffold layer. Examples of such articles are shown in FIGS. 26A-31.

It should be noted that while the methods below describe dipping the one or more scaffold layers in the liquid natural rubber, in some examples, the liquid natural rubber can be applied to the one or more scaffold layers in another way to form the one or more rubber layers over the one or more scaffold layers. For example, in some instances, the liquid natural rubber can be painted onto the one or more scaffold layers with a brush, sprayed onto the one or more scaffold layers with a spraying device, screen-printed onto the one or more scaffold layers, or applied to the one or more scaffold layers with valve jet printing.

Turning first to FIGS. 17-19, an exemplary scaffold or scaffold layer 300 is shown. The scaffold layer 300 can provide structure to the article. In some examples, the scaffold layer 300 can be multiple scaffold layers layered over one another (e.g., two or more scaffold layers having the same or different structures). In such cases, the two or more scaffold layers can each comprise a textile.

In some examples, the scaffold layer 300 is relatively stiff and assumes the overall shape of the article.

In some examples, the scaffold layer 300 is arranged over an inner liner and/or a removable last such that assumes the overall shape of the article (e.g., a boot shape, as shown in FIGS. 17-19).

The scaffold layer 300 can comprise a textile that has a mesh-like look. For example, in some instances, the scaffold layer 300 can comprise a knitted textile comprising a plurality of yarns or fibers that are knit together (e.g., to have a mesh-like appearance with openings or open cells in the knit pattern).

In some examples, as shown in FIGS. 17 and 18, a liner 302 can be inserted inside an interior of the scaffold layer 300. The liner 302 can be a sock or sockliner, in some examples. In some examples, as shown in FIGS. 17 and 18, the liner 302 can be a non-woven lining insert shaped to have an overall shape of the final article to be formed.

In some examples, pull tabs 303 can be attached to the liner 302, as shown in FIG. 17.

In some examples, pull tabs, such as the pull tabs 303 can be integrated with and extend from a top of the shaft of the scaffold layer 300 (e.g., knit with or otherwise connected to the fibers of the scaffold layer 300).

FIG. 19 shows the scaffold layer 300 and inner liner 302 adhered together via an adhesive. The outer surface 304 of the scaffold layer 300 (with the liner 302 attached to the inside the scaffold layer 300) is ready to be dipped in a liquid natural rubber to form an outer rubber layer, as described further below.

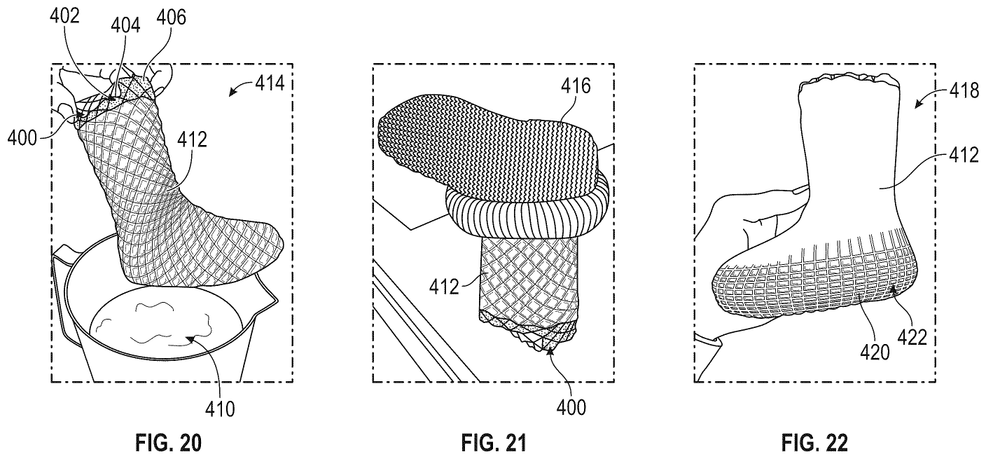

In some examples, the scaffold layer can have a mesh structure formed by a textile that comprises fibers knit together such that the resulting scaffold layer has larger openings or open cells. For example, as shown in FIGS. 20-22, a scaffold layer 400 comprises fibers that are knit, or otherwise formed, together such that a mesh structure having open cells 402 is formed. As such, the scaffold layer 400 can provide structure for the article, but also have a larger amount of flexibility (relative to a woven textile or a more tightly knit textile).

In some examples, the scaffold layer 400 can be multiple scaffold layers layered over one another (e.g., two or more scaffold layers having the same or different structures). In such cases, the two or more scaffold layers can each comprise a textile, as described below.

In some examples, the knit (e.g., the type of fibers, density of fibers, number of fibers, knit pattern or the like) of each scaffold layer in the scaffold can be the same.

In some examples, the knit (e.g., the type of fibers, density of fibers, number of fibers, knit pattern or the like) of each scaffold layer in the scaffold can be the different.

Additional scaffold layers (for example, two, three, or four scaffold layers layered over one another) can give the final article of footwear more structure. For example, two scaffold layers can result in a stiffer and more durable article of footwear than an article of footwear having only a single scaffold layer.

A desired number of scaffold layers for an article of footwear can be specified based on a desired durability for the final article of footwear (e.g., based on the intended use or user of the article).

In some examples, a second scaffold layer can be used to create decorative components or feature on targeted portions of the article of footwear. In some examples, a partial additional scaffold layer (e.g., a layer that does not cover the entire surface of the first scaffold layer) can overlay the first scaffold layer and be used to create a graphic element (after one or more liquid rubber layers are applied), such as ridges, geometrical features, logos, traction features, or the like.

Any of the scaffold layers described herein can be replaced by two or more, similar scaffold layers.

The scaffold layers described herein, including the scaffold layers 300 and 400, can comprise a textile. In some examples, the textile can comprise a knit fabric (fibers that are knit together) that is configured to stretch (and, in some instances, can be referred to herein as a “high stretch knit”). For example, fibers that are knit together result in a textile having a higher amount of stretch than textiles that comprise woven fibers.

In some examples, the textile of the scaffold layer can be a circular knit. As such, the resulting scaffold layer comprising the circular knit is seamless.

In some examples, the textile can be a plush knit fabric material.

In some examples, the textile fibers used to form the scaffold layer can comprise one or more natural fiber materials, such as cotton, wool, Luxe, Altag, linen, hemp, bamboo, and/or the like. As a result, when combined with the natural rubber of the one or more rubber layers of the article, the article can be biodegradable and healthier for the wearer and the environment.

In some examples, the textile fibers used to form the scaffold layer can comprise one or more synthetic fibers.

As shown in FIG. 20, the scaffold layer 400 comprises fibers that are knit, or otherwise formed together, to define a mesh structure (e.g., a net-like structure) having diamond-shaped open cells 402. For example, as shown in FIG. 20, each cell 402 can be defined by four segments 404 of the knit fibers.

However, in other examples, the mesh of the scaffold layer 400 can have differently shaped cells 402, such as hexagonal, elliptical, square, rectangular, and/or the like.

In some examples, as shown in FIG. 20, the scaffold layer 400 can be arranged over a last 406 having a shape of the desired article of footwear to be formed. The last 406 is configured such that it can be removed from the scaffold layer 400 after dipping and curing the one or more rubber layers thereon.

In some examples, the last 406 comprises foam.

In this way, a method for forming the article can include arranging the textile mesh scaffold layer 400 over the last 406 and dipping (or spraying, as another example) an upper portion and sole portion of the scaffold layer 400 over the last 406 into liquid natural rubber 410 to form a first rubber layer 412 of natural rubber over (covering) the scaffold layer 400.

The scaffold layer 400 can be submerged into the liquid natural rubber 410 up to a target height for a shaft of the upper.

The method can further include, after dipping, curing the liquid natural rubber 410 on the scaffold layer 400 (with the last 406 arranged therein). In some examples, curing the liquid natural rubber 410 includes curing the dipped scaffold layer 400 with heat, light, or a combination thereof. For example, the dipped scaffold layer 400 can be cured in an oven for a predetermined amount of time. As a result, the liquid natural rubber 410 covering the scaffold layer (and last 406) hardens into the first rubber layer 412.

In some examples, the method can include dipping the assembly 414 (which includes the last 406, scaffold layer 400, and first rubber layer 412) into the liquid natural rubber 410 and curing, as described above, to form a second rubber layer over the first rubber layer.

This process can be repeated until a desired thickness of rubber for the article is achieved, which may be determined based on a desired durability and flexibility of the article of footwear. These variables can vary based on the intended application for the article of footwear (e.g., walking in the rain vs. hiking or working on more rugged terrain, where additional layers of rubber may increase durability while reducing flexibility).

In some examples, the article can include an inner liner, such as a sockliner, which can provide warmth and comfort.

In some examples, as shown in FIG. 21, a sock 416 can be rolled onto the wet and uncured first rubber layer 412.

After removing the last 406, the resulting assembly can be flipped inside out (i.e., reversed) to form an article 418 which comprises an outer rubber layer (comprising the first rubber layer 412 and/or any additional rubber layers formed from multiple dips into the liquid natural rubber) with the scaffold layer 400 embedded therein and the sock 416 defining an innermost layer of the article 418. The rubber of the first rubber layer 412 extending through the cells 402 of the mesh scaffold layer 400 results in correspondingly shaped protrusions 420 (e.g., diamond-shaped protrusions) extending outward from the segments 404 of the scaffold layer 400. In some examples, this can create a design of the outsole 422 of the article 418.

For example, this can create a textured surface, or protruding nubs or lugs, that create a traction surface for the outsole 422.

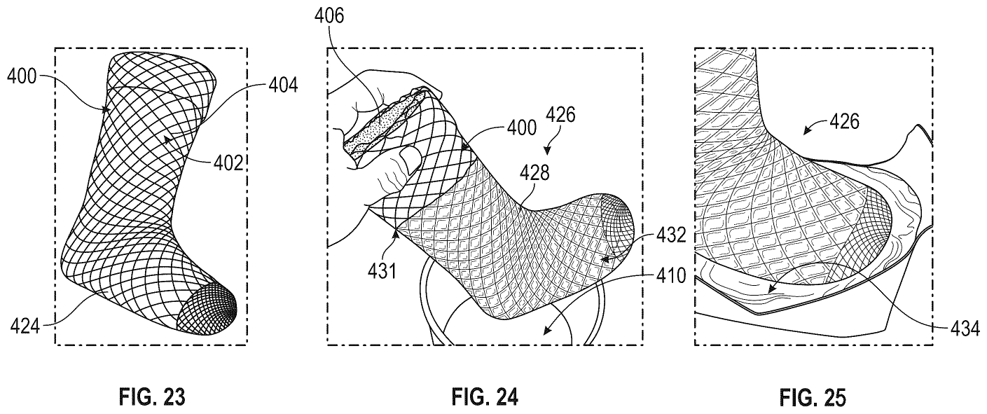

In some examples, as shown in FIG. 23, instead of rolling a sock onto the wet first rubber layer 412, the scaffold layer 400 is arranged over a sockliner 424 (which can also be referred to as a liner sock or sock). The sockliner 424 can form an innermost layer of the resulting article of footwear and can be configured to provide warmth and/or comfort to the wearer.

In some examples, as shown in FIG. 24, the sockliner 424 is arranged over the last 406 and the scaffold layer 400 is arranged over the sockliner 424, thereby forming an assembly 426. The method for forming the article can include dipping the assembly 426 into liquid natural rubber 410 to form a first rubber layer 428 of natural rubber over (covering) the scaffold layer 400 and the sockliner 424.

For example, the liquid natural rubber can coat the segments 404 of the scaffold layer and extend into the open cells 402 of the scaffold layer to the sockliner 424. As such, the scaffold layer can become at least partially embedded in the first rubber layer 428.

The first rubber layer 428 can be cured, as explained above.

If additional layers of natural rubber are desired, the assembly 426 can be dipped into the liquid natural rubber 410 (or the liquid natural rubber can be sprayed onto the assembly 426) additional times to form additional layers or rubber over the first rubber layer 428.

The assembly 426 can be dipped into the liquid natural rubber 410 up to a specified location on the shaft of the assembly 426 (marked with arrow 431 in FIG. 24 for reference) that corresponds to the desired height of the upper of the article. In this way, a same assembly 426 can be used to form articles having different upper shaft heights.

In some examples, the method for forming the article can include dipping only a sole portion 432 of the assembly 426, with the first rubber layer 428 cured thereon, into the liquid natural rubber 410 to form a second rubber layer over only the sole portion 432.

The liquid natural rubber can be a first liquid natural rubber. In some examples, the method for forming the article can include dipping only the sole portion 432 of the assembly 426, with the first rubber layer 428 cured thereon, into a second liquid natural rubber 434 to form a second rubber layer 436 over only the sole portion 432. In this way, the resulting article 438 (shown in FIGS. 26A and 26B) can comprise an outsole 430 that is thicker than an upper 437 of the article 438.

For example, in some instances, the outsole 430 comprises two layers of rubber while the upper 437 comprises a single layer of rubber. In some examples, the outsole 430 comprises three layers of rubber while the upper 437 comprises two layers of rubber.

In some examples, the second liquid natural rubber 434 can have a higher durometer than the first liquid natural rubber 410. As a result, the outsole 430 can have a greater hardness than the upper 437.

In some examples, the second liquid natural rubber 434 can include or have a different color than the first liquid natural rubber 410. For example, as shown in FIGS. 26A and 26B, the outsole 430 comprising the second natural rubber can have a specified color or streaks of color that is different than a color of the upper 437.

In this way, outsoles, such as outsole 430, having various colors, patterns, designs, durometers, and/or other material properties can be easily created by utilizing different liquid natural rubbers.

In some examples, the first liquid natural rubber 410 can be colored or have streaks of color to produce the upper 437 with a specified color and/or pattern.

As introduced above, the natural rubbers used to form the rubber layers of the articles described herein (such as the liquid natural rubbers 410 and 434) can be a natural rubber material, such as a natural rubber latex. In some examples, the natural rubber latex is Vytex, which is produced from the Hevea Brasiliensis tree. As such, the natural rubber used to form the articles, such as article 438, can be renewable and biodegradable. The natural rubber is also waterproof, elastomeric, and adhesive (e.g., it can adhere to various materials, such as the scaffold layers 300 and 400 and other rubber layers when being used to form multiple layers).

The mesh scaffold layer of the articles described herein, such as scaffold layer 300 or scaffold layer 400 can provide lightweight structure to the article while also enabling the article to bend and flex for ease of movement. The one or more rubber layers, such as rubber layers 412, 428, and 436, can provide the articles with a waterproof skin over the scaffold layer that effectively repels water without adding much weight to the article.

In some examples, the articles described herein can include a midsole comprising cork. For example, in some instances, the scaffold layer (such as the scaffold layers 300 or 400) can comprise a cork layer or sheet in a sole portion of the scaffold layer (such as above the bottom of the scaffold forming the outsole). In some instances, a cork insole or midsole can be inserted or molded into the bottom of the scaffold layer, and then the last arranged inside the scaffold layer, prior to dipping or spraying with the liquid natural rubber.

In some examples, existing articles of footwear, existing uppers, or existing uppers and sole members, can be dipped into or sprayed with the liquid natural rubber described herein, thereby creating articles of footwear with an outer natural rubber latex coating that is waterproof.

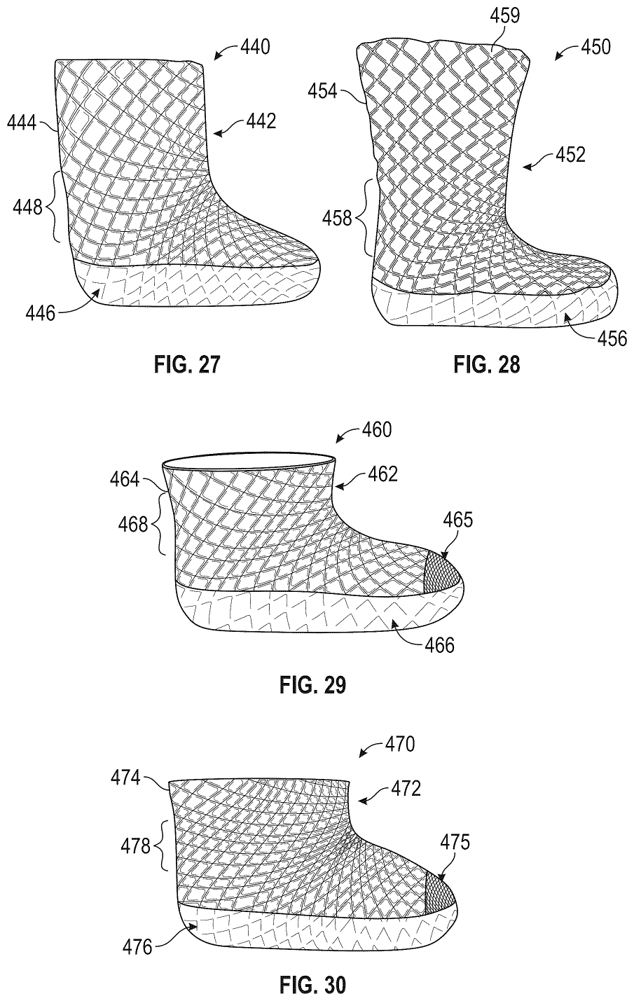

FIGS. 27-30 show different articles that can be formed using any of the methods described above with reference to FIGS. 17-25. Thus, each of the articles shown in FIGS. 27-30 comprises a scaffold layer with one or more rubber layers covering the scaffold layer. FIGS. 17-30 depict how articles having different shapes, shaft heights, mesh structures, or the like, can be formed from a scaffold layer and one or more layers of natural rubber.

For example, FIG. 27 shows a first article 440 having an upper 442 with a longer shaft 444 (as compared to articles 460 and 470 in FIGS. 29 and 30, respectively). The first article 440 has an outsole 446 that is thicker or has a higher durometer rubber than the upper 442. The upper 442 has an ankle region 448 that is wider and less defined, as compared to the ankle region 458 of article 450 in FIG. 28.

FIG. 28 shows a second article 450 having an upper 452 with a longer shaft 454 (as compared to articles 460 and 470 in FIGS. 29 and 30, respectively). The second article 450 has an outsole 456 that is thicker or has a higher durometer rubber than the upper 452. The upper 452 has an ankle region 458 that is narrower and more defined, as compared to the ankle region of article 440 in FIG. 27. Further, the upper 452 has a larger opening 459 that tapers to the narrower ankle region 458.

FIG. 29 shows a third article 460 having an upper 462 with a shorter shaft 464 (as compared to articles 440 and 450 in FIGS. 27 and 28, respectively). The third article 460 has an outsole 466 that is thicker or has a higher durometer rubber than the upper 462. The upper 462 has a toe region 465 with a finer mesh in the underlying scaffold layer. As a result, the toc region 465 can have increased structure and strength, thereby protecting the wearer's toes.

In some examples, a finer or differently shaped mesh can be used in different regions of the articles described herein to achieve a target level of flexibility, durability, and structure.

FIG. 30 shows a fourth article 470 having an upper 472 with a shorter shaft 474 (as compared to articles 440 and 450 in FIGS. 27 and 28, respectively). The fourth article 470 has an outsole 476 that is thicker or has a higher durometer rubber than the upper 472. The upper 472 has an ankle region 478 that is wider and less defined, as compared to the ankle region 468 of article 460 in FIG. 29. The upper 472 has a toe region 475 with a finer mesh in the underlying scaffold layer. As a result, the toe region 475 can have increased structure and strength, thereby protecting the wearer's toes.

As shown in FIGS. 29 and 30, the scaffold layers of the articles 460 and 470, respectively can have a finer mesh (e.g., smaller cells) than the articles 440 and 450.

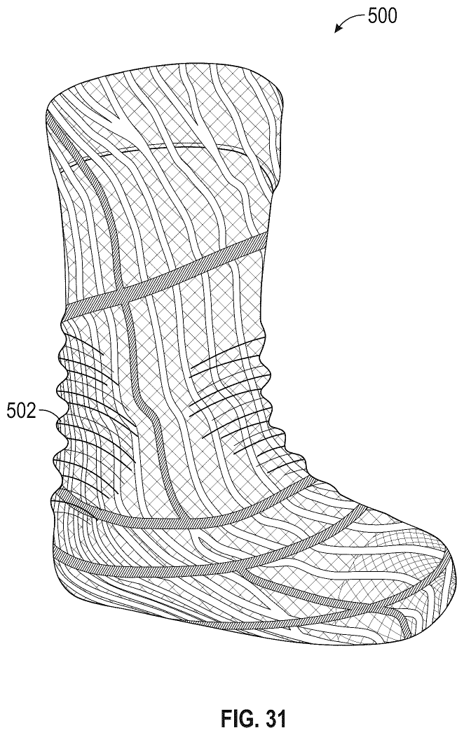

FIG. 31 depicts a scaffold layer 500 that can be used with any of the methods described above with reference to FIGS. 17-25 to form an article comprising one or more rubber layers with pleats. As shown in FIG. 31, the scaffold layer 500 comprises fibers knit such that protruding baffles 502 (which can also be referred to herein as pleats or pleated structure) are formed. The baffles 502 can include one or more rows of raised and recessed portions in the scaffold layer 500.

When dipped into liquid natural rubber, as described above, the resulting article can have pleats in the region of the baffles 502, thereby forming an article having a structure similar to the article 150 in FIGS. 8A-8B.

As introduced above, in some examples, the articles described herein can be formed by dipping a foot form one or more times into liquid natural rubber (or spraying the liquid natural rubber onto the foot form), curing the rubber layers on the foot form, and removing the formed article from the foot form. The foot form can have the shape of the article of footwear to be formed, including any pleats, traction features, or other elements to be included in the article.

FIGS. 32 and 33 depict two exemplary foot forms that can be used to create a waterproof article comprising pleats. It should be noted that the foot forms can be adapted to have the shapes, including the pleat arrangements, of any of the articles described herein or similar articles (such as the articles shown in FIGS. 1-16B).

FIG. 32 depicts a foot form 600 comprising an upper portion 602 and a sole portion 606. A shaft 608 of the upper portion 602 comprises a plurality of longitudinally extending pleats 610 (which can also be referred to herein as ridges or elongate protrusions) spaced apart around the shaft 608.

FIG. 33 depicts another foot form 620 comprising an upper portion 622 and a sole portion 626. A shaft 628 of the upper portion 622 comprises a plurality of longitudinally extending pleats 630 spaced apart around the shaft 628.

The upper portion 622 also includes pleats 632 that are spaced apart from one another and extend across a front ankle portion 634 of the foot form 620, toward a heel portion 636 of the foot form 620.

In some examples, pleats of a foot form, such as pleats 630 and 632, can be referred to as ridges (or protrusions) that protrude outward from a base surface of the foot form.

As noted above, the foot form 620 can be adapted to have any arrangement of ridges or pleats, such as any of the arrangements shown in FIGS. 1-15B. For example, in some instances, the outsole portion of the foot form can comprise nubs, raised rings, or other surface features that results in traction features or textures on the outsole of the resulting article of footwear.

FIGS. 34 and 35 depict a method for forming an article of footwear (e.g., the article 650 shown in FIGS. 37A and 37B) using the foot form 620. The method described below with reference to FIGS. 34 and 35 can be applied to a variety of foot forms having different shapes and pleat arrangements such that natural, waterproof articles of footwear having a variety of shapes, pleat arrangements, and/or tractions features can be produced.

It should be noted that while the methods described below include dipping the foot form into the liquid rubber, in some examples, the liquid rubber can be applied to the foot form in another way to form the one or more rubber layers over the foot form. For example, in some instances, the liquid natural rubber can be painted onto the foot form with a brush, sprayed onto the foot form with a spraying device, screen printed onto the foot form, or applied to the foot form with valve jet printing.

As shown in FIG. 34, the method for forming the article includes dipping the foot form 620 (or another foot form) into liquid natural rubber 638 (e.g., the natural rubber described herein) to form a first rubber layer 640 on the foot form 620.

In some examples, additives can be included in any of the liquid natural rubbers described herein.

For example, in some instances additives can be included in the liquid natural rubber that thicken the liquid natural rubber and result in thicker rubber layers on the foot form.

In some examples, the additives can include a micro cellulose matrix additive.

In some examples, the additives can include a mineral curing additive that promotes curing of the liquid natural rubber once applied to the foot form or scaffold layer.

As already mentioned above, in some examples, additives in the form of colorants can be added to the liquid natural rubber to produce rubber layers of different colors, patterns, or the like.

The method can further include, after dipping, curing the first rubber layer 640 on the foot form 620. In some examples, curing includes curing the first rubber layer 640 on the foot form 620 with heat, light, or a combination thereof. For example, the first rubber layer 640 can be cured in an oven for a predetermined amount of time. As a result, first rubber layer 640 hardens on the foot form 620.

In some examples, the method can include dipping the assembly 642, which includes the cured first rubber layer 640 on the foot form 620, as shown in FIG. 35, into the liquid natural rubber 638 again and curing, as described above, to form a second rubber layer over the first rubber layer 640.

This process can be repeated until a desired thickness of rubber for the article is achieved, which may be determined based on a desired durability and flexibility of the article of footwear. These variables can vary based on the intended application for the article of footwear (e.g., walking in the rain vs. hiking or working on more rugged terrain, where additional layers of rubber may increase durability while reducing flexibility).

In some examples, a outsole that is harder and/or colored differently than the upper of the formed article can be created by dipping only the sole portion 626 of the foot form 620 into the liquid natural rubber 638 an additional one or more times or dipping only the sole portion 626 of the foot form 620 into a different liquid natural rubber having a higher durometer and/or a different color, as described above.

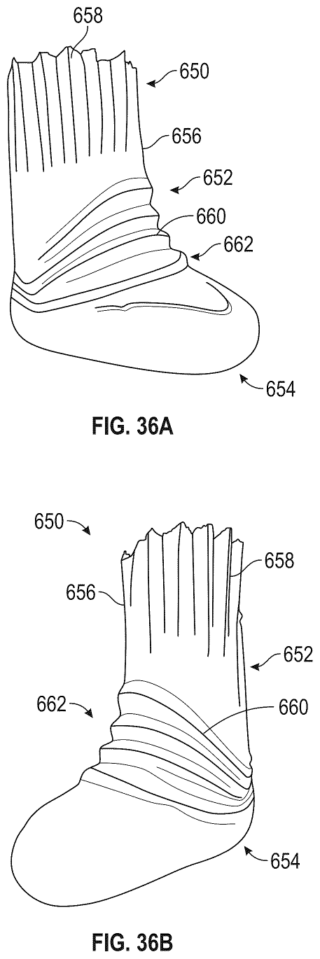

After achieving the desired number of rubber layers and a final curing, the formed article can be removed from the foot form 620 (the formed article 650 is shown in FIGS. 36A and 36B).

In some examples, the resulting article 650 shown in FIGS. 36A and 36B, includes three layers of rubber.

The article 650 comprises an upper 652 and sole member 654 that are integral with one another (formed as one piece).

In some examples, the article 650, or other articles formed with the method described above, can include a midsole, such as a cork midsole, placed or molded within an interior of the article 650.

In some examples, the article 650, or other articles formed with the method described above, can include an inner liner, such as a sockliner (or “liner sock”) arranged inside the formed article.

In some examples, a liner sock can be formed on the inside of the formed article, such as article 650, by spraying natural fibers on the interior surface of the formed article (which can be referred to as “flocking”) until a desired thickness of the liner sock is achieved. For example, after the liquid rubber is applied to the foot form, fibers can be flocked onto the outermost rubber layer and then the article can be flipped inside out to obtain a waterproof article of footwear with an inner liner sock.

As shown in FIGS. 36A and 36B, a shaft 656 of the upper 652 includes longitudinally extending pleats 658 spaced apart around the shaft 656 (formed by pleats 630 on the foot form 620). The upper 652 also includes pleats 660 extending across an ankle region 662 of the article 650 (formed by pleats 632 on the foot form 620).

As a result, the formed article 650 provides a waterproof article that is flexible, particularly in the region of the pleats 658 and 660 and allows freedom of movement while being comfortable.

As explained above, in some examples, a different liquid polymer or liquid rubber can be used with any of the methods described herein (instead of natural liquid rubber) to create articles with one or more layers of polymer or rubber.

In some examples, all the methods and articles of footwear described herein can utilize natural rubber, which requires less processing, is from a regenerative rubber source, and is biodegradable. Thus, the articles of footwear described herein are healthier for both the wearer and the environment.

Additionally, the methods disclosed herein of applying a liquid rubber to a scaffold layer or foot form results in a seamless upper and outsole made with rubber that is waterproof.

By utilizing pleats in the rubber layers and/or highly flexible knit textiles to form the scaffold layers, the resulting articles of footwear are highly flexible, as well as having increased bendability in targeted regions of the articles that experience more movement when worn, such as the ankle region. As such, the wearer, such as a child, can move naturally without being inhibited by the article.

Further, the shape of the scaffold layers and foot forms disclosed herein follow a natural anatomy and alignment of the intended wearer, such as for a child's growing foot. The shape, along with the flexibility and minimal construction of the articles describe herein creates seamless articles having a second skin sensation.

The textile materials included in the articles of footwear, such as the textile scaffold layers, inner liners, and/or cuffs can also comprise natural materials, such as natural fibers that provide warmth, comfort, and are environmentally friendly.

The disclosed methods for creating waterproof articles by applying liquid rubber (or another liquid polymer) to scaffold layers or foot forms can reduce manufacturing waste by only depositing as much liquid rubber material as needed onto the scaffold layer or foot form. As a result, the disclosed methods for forming the waterproof articles are fast and affordable.

By being a composite of minimal materials (e.g., the textile scaffold layer and one or more rubber layers, or just multiple rubber layers), the resulting articles are lightweight, thereby furthering the ease of movement when wearing the articles.

Any of the technologies herein could be applied to an article of apparel other than footwear, such as gloves, jackets, hats, or the like. For example, an article of apparel can include be formed from an appropriately shaped textile scaffold or form which is dipped in the liquid natural rubber, or sprayed with the liquid natural rubber, as described herein, thereby forming a waterproof or water-resistant article of apparel.

### Additional Examples of the Disclosed Technology

Additional examples of the disclosed technology are enumerated below.

Example 1. A method for forming an article of footwear, comprising arranging a scaffold layer over a last having a shape of the article of footwear to form a scaffold assembly, wherein the scaffold layer comprises a textile with a mesh structure; applying a liquid rubber to an upper portion and sole portion of the scaffold assembly to form one or more layers of rubber over the scaffold layer, thereby forming a seamless article of footwear; and removing the formed article of footwear from the last.

Example 2. The method of any example herein, particularly example 1, wherein the textile comprises natural fibers that are knit together to form the mesh structure having open cells.

Example 3. The method of any example herein, particularly example 2, wherein the open cells are diamond shaped.

Example 4. The method of any example herein, particularly either example 2 or example 3, wherein applying the liquid rubber to the upper portion and sole portion of the scaffold assembly includes coating the fibers of the scaffold layer with liquid rubber and extending the liquid rubber into the open cells of the scaffold layer.

Example 5. The method of any example herein, particularly any one of examples 1-4, wherein the one or more layers of rubber is a first layer of rubber, and further comprising applying the liquid rubber to only the sole portion of the scaffold assembly to form a second layer of rubber over only the sole portion.

Example 6. The method of any example herein, particularly any one of examples 1-5, wherein the scaffold layer defines one or more pleated structures.

Example 7. The method of any example herein, particularly example 6, wherein the pleated structures comprise one or more rows of raised and recessed portions, and wherein applying the liquid rubber to the scaffold layer forms regions forms flexible zones in which the article of footwear has greater flexibility.

Example 8. The method of any example herein, particularly any one of examples 1-7, wherein the one or more layers of rubber is a first layer of rubber and the liquid rubber is a first liquid rubber, and further comprising applying a second liquid rubber to only the sole portion of the scaffold assembly to form a second layer of rubber over only the sole portion, and wherein the second liquid rubber has a higher durometer than the first liquid rubber.

Example 9. The method of any example herein, particularly any one of examples 1-8, further comprising curing the one or more layers of rubber over the scaffold layer in an oven prior to removing from the last.

Example 10. The method of any example herein, particularly any one of examples 1-9, further comprising after applying the liquid rubber to the upper portion and sole portion of the scaffold assembly to form one or more layers of rubber over the scaffold layer, rolling a sockliner onto one or more layers of rubber while still wet; and reversing the scaffold assembly with the one or more rubber layers and sockliner thereon inside out to form the article of footwear comprising one or more outer rubber layers with the scaffold layer embedded therein and the sockliner defining an innermost layer of the article of footwear.

Example 11. The method of any example herein, particularly any one of examples 1-9, wherein arranging the scaffold layer over the last includes arranging a sockliner over the last and arranging the scaffold layer over the sockliner.

Example 12. The method of any example herein, particularly any one of examples 1-11, wherein applying the liquid rubber to the upper portion and sole portion of the scaffold assembly includes dipping the upper portion and sole portion of the scaffold assembly into the liquid rubber.

Example 13. The method of any example herein, particularly any one of examples 1-12, wherein applying the liquid rubber to the upper portion and sole portion of the scaffold assembly includes dipping the upper portion and sole portion of the scaffold assembly into the liquid rubber.

Example 14. An article of footwear comprising one or more inner scaffold layers, wherein the one or more inner scaffold layers comprise textile fibers that are knit together to define a mesh structure having open cells; and one or more rubber layers comprising a rubber disposed over and within the open cells of the one or more inner scaffold layers, wherein the article is seamless and together the inner scaffold layer and one or more rubber layers define an upper and sole member of the article that are formed as one piece.

Example 15. The article of any example herein, particularly example 14, wherein the rubber is a natural rubber latex obtained from trees.

Example 16. The article of any example herein, particularly either example 14 or example 15, wherein the sole member comprises an outsole that has a greater hardness than the upper.

Example 17. The article of any example herein, particularly any one of examples 14-16, wherein the sole member comprises an outsole, the outsole comprises at least one more rubber layer than the upper such that the outsole is thicker than the upper.

Example 18. The article of any example herein, particularly any one of examples 14-17, wherein the one or more inner scaffold layers have a plurality of pleats that define one or more flexible zones in which the article of footwear has greater flexibility.

Example 19. A method for forming an article of footwear, comprising applying a liquid rubber to a foot form to form a first layer of rubber over the foot form, wherein the foot form comprises an upper portion and a sole portion, and wherein the upper portion comprises a plurality of spaced apart ridges that protrude outward from a base surface of the foot form; applying the liquid rubber to the first layer of rubber on the foot form to form a second layer of rubber over the first layer of rubber; curing the first and second layers of rubber on the foot form, thereby forming the article of footwear comprising an outsole and an upper that are seamless with one another, and wherein the upper comprises a plurality of pleats having a shape of the plurality of spaced apart ridges; and removing the formed article of footwear from the foot form.

Example 20. The method of any example herein, particularly example 19, wherein at least a portion of the plurality of pleats is formed in an ankle region of the upper of the article.

Example 21. The method of any example herein, particularly either example 19 or example 20, wherein at least a portion of the plurality of pleats is formed in a shaft of the upper, and wherein each pleat of the portion of the plurality of pleats extends from an opening of the upper toward the outsole.

Example 22. The method of any example herein, particularly any one of examples 19-21, further applying the liquid rubber to the second layer of rubber on the foot form to form a third layer of rubber over the second layer of rubber, and wherein the formed article of footwear comprises three layers of rubber.

Example 23. The method of any example herein, particularly any one of examples 19-22, wherein applying the liquid rubber to the foot form includes dipping the foot form into the liquid rubber, and wherein applying the liquid rubber to the first layer of rubber includes dipping the foot form with the first layer of rubber formed thereon into the liquid natural rubber.

Example 24. An article of footwear comprising an upper and outsole that are seamless with one another, wherein the upper and outsole comprise one or more layers of rubber, and wherein the upper comprises a plurality of spaced apart pleats in an ankle region of the upper that are configured to increase bendability of the upper in the ankle region.

Example 25. The article of any example herein, particularly example 24, wherein the outsole comprises a plurality of protruding elements configured to provide traction to the outsole.

Example 26. The article of any example herein, particularly either example 24 or example 25, wherein the plurality of spaced apart pleats is a plurality of first pleats, and wherein the upper comprises a plurality of spaced apart second pleats spaced apart around an opening of the upper that are configured to allow the opening to stretch.

In view of the many possible examples to which the principles of the disclosed technology may be applied, it should be recognized that the illustrated examples are only preferred examples of the disclosed technology and should not be taken as limiting the scope of the claimed subject matter. Rather, the scope of the claimed subject matter is defined by the following claims and their equivalents.

1. A method for forming an article of footwear, comprising:
arranging a scaffold layer over a last having a shape of the article of footwear to form a scaffold assembly, wherein the scaffold layer comprises a textile with a mesh structure;
applying a liquid rubber to an upper portion and sole portion of the scaffold assembly to form one or more layers of rubber over the scaffold layer, thereby forming a seamless article of footwear; and
removing the formed article of footwear from the last.

2. The method of claim 1, wherein the textile comprises natural fibers that are knit together to form the mesh structure having open cells.

3. The method of claim 2, wherein the open cells are diamond shaped.

4. The method of claim 2, wherein applying the liquid rubber to the upper portion and sole portion of the scaffold assembly includes coating the fibers of the scaffold layer with liquid rubber and extending the liquid rubber into the open cells of the scaffold layer.

5. The method of claim 1, wherein the one or more layers of rubber is a first layer of rubber, and further comprising applying the liquid rubber to only the sole portion of the scaffold assembly to form a second layer of rubber over only the sole portion.

6. The method of claim 1, wherein the scaffold layer defines one or more pleated structures.

7. The method of claim 6, wherein the pleated structures comprise one or more rows of raised and recessed portions, and wherein applying the liquid rubber to the scaffold layer forms regions forms flexible zones in which the article of footwear has greater flexibility.

8. The method of claim 1, wherein the one or more layers of rubber is a first layer of rubber and the liquid rubber is a first liquid rubber, and further comprising applying a second liquid rubber to only the sole portion of the scaffold assembly to form a second layer of rubber over only the sole portion, and wherein the second liquid rubber has a higher durometer than the first liquid rubber.

9. The method of claim 1, further comprising:
after applying the liquid rubber to the upper portion and sole portion of the scaffold assembly to form one or more layers of rubber over the scaffold layer, rolling a sockliner onto one or more layers of rubber while still wet; and
reversing the scaffold assembly with the one or more rubber layers and sockliner thereon inside out to form the article of footwear comprising one or more outer rubber layers with the scaffold layer embedded therein and the sockliner defining an innermost layer of the article of footwear.

10. The method of claim 1, wherein arranging the scaffold layer over the last includes arranging a sockliner over the last and arranging the scaffold layer over the sockliner.

11. An article of footwear comprising:
one or more inner scaffold layers, wherein the one or more inner scaffold layers comprise textile fibers that are knit together to define a mesh structure having open cells; and
one or more rubber layers comprising a rubber disposed over and within the open cells of the one or more inner scaffold layers, wherein the article is seamless and together the one or more inner scaffold layers and one or more rubber layers define an upper and sole member of the article that are formed as one piece.

12. The article of claim 11, wherein the rubber is a natural rubber latex obtained from trees.

13. The article of claim 11, wherein the sole member comprises an outsole that has a greater hardness than the upper.

14. The article of claim 11, wherein the sole member comprises an outsole, the outsole comprises at least one more rubber layer than the upper such that the outsole is thicker than the upper.

15. The article of claim 11, wherein the one or more inner scaffold layers have a plurality of pleats that define one or more flexible zones in which the article of footwear has greater flexibility.

16. A method for forming an article of footwear, comprising:
applying a liquid rubber to a foot form to form a first layer of rubber over the foot form, wherein the foot form comprises an upper portion and a sole portion, and wherein the upper portion comprises a plurality of spaced apart ridges that protrude outward from a base surface of the foot form;
applying the liquid rubber to the first layer of rubber on the foot form to form a second layer of rubber over the first layer of rubber;
curing the first and second layers of rubber on the foot form, thereby forming the article of footwear comprising an outsole and an upper that are seamless with one another, and wherein the upper comprises a plurality of pleats having a shape of the plurality of spaced apart ridges; and
removing the formed article of footwear from the foot form.

17. The method of claim 16, wherein at least a portion of the plurality of pleats is formed in an ankle region of the upper of the article.

18. The method of claim 16, wherein at least a portion of the plurality of pleats is formed in a shaft of the upper, and wherein each pleat of the portion of the plurality of pleats extends from an opening of the upper toward the outsole.

19. The method of claim 16, further comprising applying the liquid rubber to the second layer of rubber on the foot form to form a third layer of rubber over the second layer of rubber, and wherein the formed article of footwear comprises three layers of rubber.

20. The method of claim 16, wherein applying the liquid rubber to the foot form includes dipping the foot form into the liquid rubber, and wherein applying the liquid rubber to the first layer of rubber includes dipping the foot form with the first layer of rubber formed thereon into the liquid natural rubber.
